(19) United States
(12) Patent Application Publication
(10) Pub. No.: US 2002/0078723 A1
(43) Pub. Date: Jun. 27, 2002

(54) Off-set steering wheel lock

(75) Inventor: Robert V. Vickers, Chagrin Falls, OH (US)

Correspondence Address: Vickers, Daniels & Young, 50 Public Square, Suite 2000, Cleveland, OH, 44113-2235, US

(73) Assignee: Winner International Royalty LLC

(21) Appl. No.: 09/747,689

(22) Filed: Dec. 27, 2000

(51) Int. Cl. B60R 25/02

(52) U.S. Cl. 70/209

(57) ABSTRACT

An anti-theft device for preventing unauthorized use of an automobile by prohibiting rotation of the steering wheel. The device including first and second telescopic members with a lock for securing the members in an extended locked condition. The device further including opposing hooks for engaging the rim of the steering wheel and at least one stand off element for spacing the telescoping members from the rim.

This invention relates to the art of anti-theft devices for automobiles, and more particularly to a steering wheel lock for preventing the unauthorized use of an automobile by prohibiting rotation of the steering wheel when the steering wheel lock is in the installed position.

### INCORPORATION BY REFERENCE

The present invention prevents unauthorized use of an automobile by selectively lockingly engaging the rim of the steering wheel and by including a blocking member that extends radially beyond the rim of the steering wheel. Such anti-theft devices are well known in the art and are generally shown and described in Wu U.S. Pat. No. 4,935,047 and Johnson U.S. Pat. No. 4,856,308. These patents are incorporated by reference herein as background information illustrating steering wheel locks which mount diametrically across the rim of the steering wheel and include a portion extending radically beyond the same adapted to block rotation of the steering wheel.

### BACKGROUND OF THE INVENTION

It is, of course, well known that a device which selectively prevents rotation of a steering wheel is an effective theft deterrent. However, preventing unauthorized rotation of a steering wheel can be accomplished in many ways. In this respect, as is shown in Liou U.S. Pat. No. 5,052,201, disclosed is a device which interengages the steering wheel at generally one location and includes a handle member that extends radially beyond the rim of the steering wheel to prevent rotation. Fuller U.S. Pat. No. 5,055,823 also discloses a steering wheel lock which engages the steering wheel at generally one point. However, this device includes a handle tangent to the rim at the point of engagement. Pazik U.S. Pat. No. 5,197,308 discloses a steering wheel lock which engages the hub of the steering wheel. Other devices, as with the present invention, include opposing hooks connected to each of two telescoping engaging elongated members that mount diametrically across the rim of the steering wheel.

The problem with steering wheel locks which mount diametrically across the rim of the steering wheel is that steering wheels which include air bags can have a steering hub which extends laterally beyond the rim of the steering wheel. Furthermore, the hub of the steering wheel typically includes the horn mechanism of the vehicle. As a result, steering wheel locks, such as shown in Wu and Johnson, can be difficult to install due to the obstruction formed by the outwardly extending steering hub and can often activate the vehicle's horn inadvertently during installation. Further, these diametrical steering wheel locks may not fit some steering wheels.

### SUMMARY OF THE INVENTION

In accordance with the present invention, an improved steering wheel lock is provided which advantageously attaches to virtually all steering wheels even though it mounts diametrically across the rim of the steering wheel. Further, the steering wheel lock according to the present invention reduces the likelihood of inadvertently activating the vehicle's horn during installation of the anti-theft device on the steering wheel. In this respect, a steering wheel lock according to the present invention provides clearance between the telescoping members and the steering wheel hub when the steering wheel lock is in the installed position even though the steering wheel lock mounts diametrically to the steering wheel rim. Further, even though clearance is provided between the telescoping members and the steering wheel hub, the diametrically mounted steering wheel lock still prevents theft of the air bag system mounted within the steering wheel hub by partially covering the hub.

The foregoing advantages are achieved in accordance with the present invention by spacing the rim engaging hooks from the telescoping members. In this respect, a stand off is provided between each of the wheel rim engaging hooks and the corresponding telescoping member. Further, the stand off can be configured to provide additional hook portions to allow the diametrically mounted steering wheel lock to be mounted in multiple positions providing adjustment in the spacing between the rim engaging hooks and the telescoping members.

It is accordingly an outstanding object of the present invention to provide an improved diametrically mounted steering wheel lock that produces clearance between the steering wheel hub and the telescoping members of the steering wheel lock.

A further object is the provision of a steering wheel lock of the foregoing character which easily allows adjustment of the clearance between the telescoping members and the steering wheel hub.

Another object is the provision of a steering wheel lock of the foregoing character that can be easily installed and uninstalled on the rim of a steering wheel.

Still another object is the provision of a steering wheel lock of the foregoing character that maintains protection of the air bag system within the steering wheel hub while providing clearance between the hub and the telescoping members of the steering wheel lock.

Yet another object is the provision of a steering wheel lock of the foregoing character which is economical to manufacture and is an effective theft deterrent device.

### BRIEF DESCRIPTION OF THE DRAWINGS

The foregoing objects, and others, will in part be obvious and in part be pointed out more fully hereinafter in conjunction with the written description of the preferred embodiments of the present invention illustrated in the accompanied drawings in which:

FIG. 1 is a perspective view of a first embodiment of the steering wheel lock in accordance with the present invention shown in an installed position on a steering wheel rim;

FIG. 2 is a top view of the steering wheel lock shown in FIG. 1 which is shown in the installed position;

FIG. 3 is an end view taken along line 3-3 of FIG. 1;

FIG. 4 is an enlarged sectional view taken along line 4-4 of FIG. 1 showing a first lock mechanism;

FIG. 5 is an enlarged sectional view taken along line 5-5 of FIG. 1 further showing the first lock mechanism;

FIG. 6 is a perspective view of another embodiment of the steering wheel lock in accordance with the present invention having a second lock mechanism;

FIG. 7 is an end view taken along line 7-7 of FIG. 6;

FIG. 8 is an enlarged sectional view taken along line 8-8 of FIG. 6 further showing the second lock mechanism;

FIG. 9 is an enlarged sectional view taken along line 9-9 of FIG. 6 further showing the second lock mechanism;

FIG. 10 is a perspective view of the steering wheel lock shown in FIG. 1 having a third lock mechanism;

FIG. 11 is an enlarged sectional view taken along line 11-11 of FIG. 10 showing the third lock mechanism;

FIG. 12 is an enlarged sectional view taken along line 12-12 of FIG. 11 further showing the third lock mechanism;

FIG. 13 is an enlarged sectional view taken along line 13-13 of FIG. 12 further showing the third lock mechanism; and

FIG. 14 is an enlarged sectional view taken along line 14-14 of FIG. 12 further showing the third lock mechanism.

### DESCRIPTION OF THE PREFERRED EMBODIMENTS

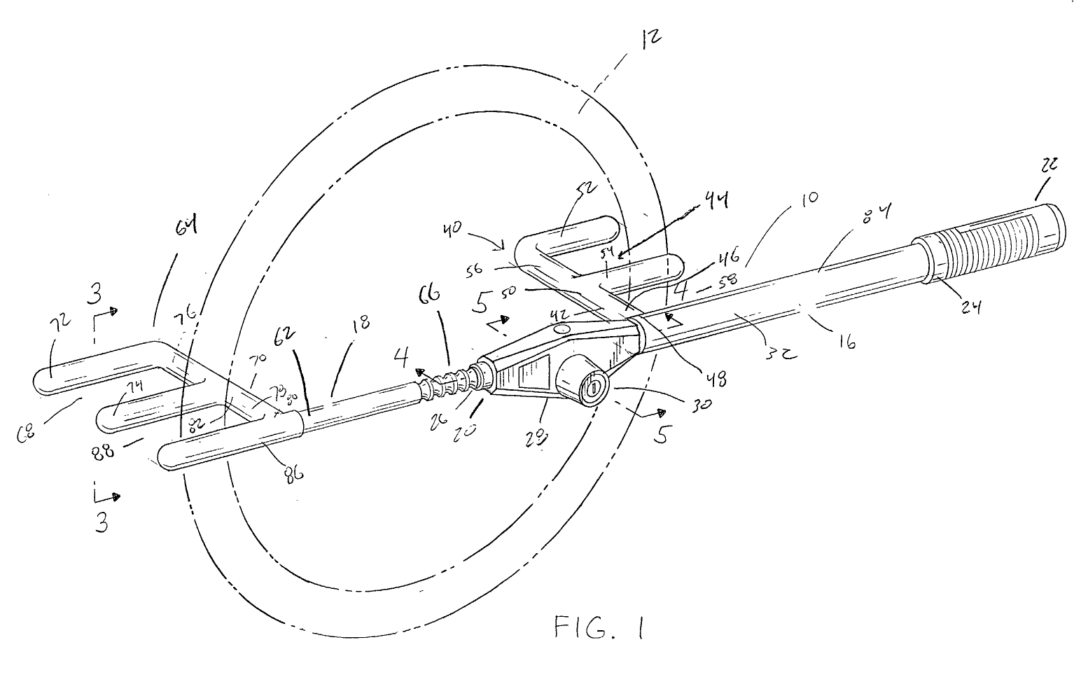

Referring now in greater detail to the drawings wherein the showings are for the purpose of illustrating preferred embodiments of the invention only, and not for the purpose of limiting the same, FIG. 1 illustrates a steering wheel lock 10 mounted diametrically on outer rim 12 of steering wheel 14. Steering wheel lock 10 includes a tubular handle member 16 which telescopically receives elongated rod 18. More particularly, handle member 16 has an opened end 20 and an outer end 22. Outer end 22 can include a plastic handle 24 to aid in the installation of the wheel lock 10 and to provide cushioned engagement with the handle 16 and the interior of the vehicle. Opened end 20 includes a rod receiving opening 26 adjacent lock housing portion 28. The lock housing 28 encloses a lock 30 which prevents unauthorized retraction of rod member 20 with respect to handle member 16 in any one of a plurality of axially spaced positions. Lock 30 will be discussed in greater detail below.

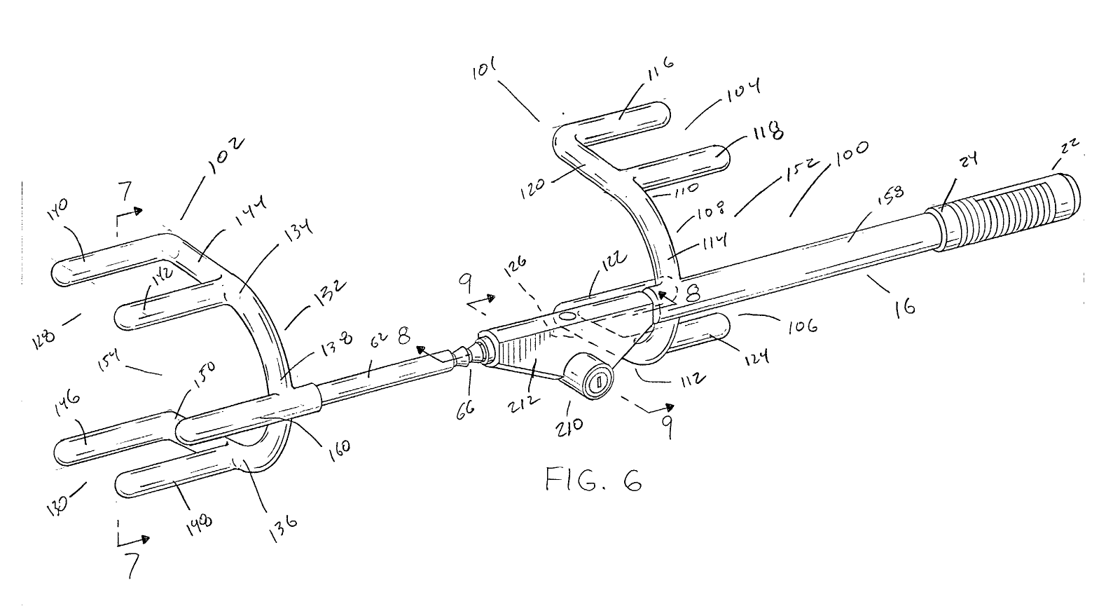

Tubular handle member 16 further comprises an elongated tube 32 having a circular cross section about an axis A. Elongated tube 32 includes an elongated passageway 34 extending from rod receiving opening 26 toward outer end 22. Elongated passageway 34 has a circular cross section concentric about the axis A. In addition, elongated tube 32 is comprised of inner sleeve 36 and outer sleeve 38 producing a double wall construction best shown in FIGS. 6 and 8. A portion of elongated tube 32 extends within lock housing 28 thereby securing lock housing 28 to elongated tube 32.

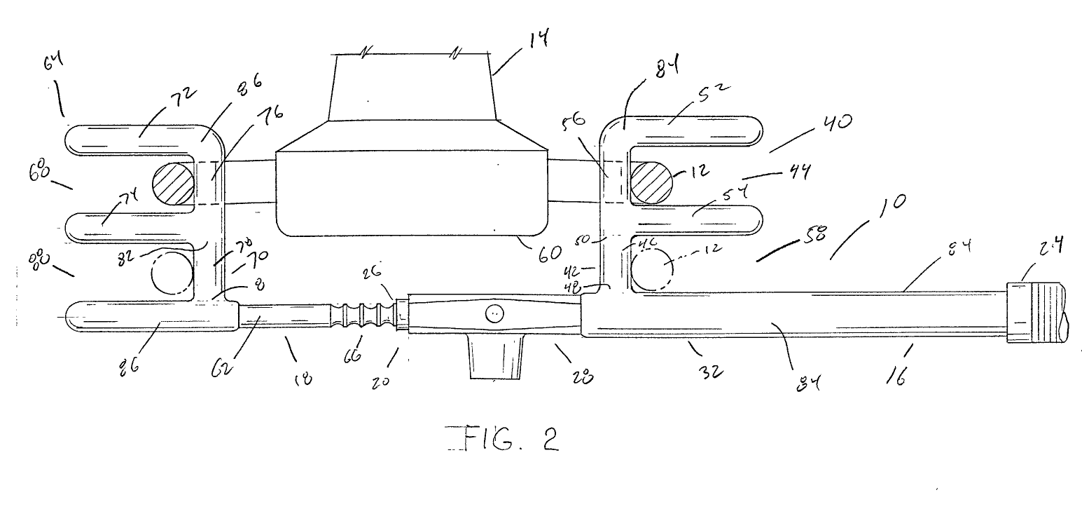

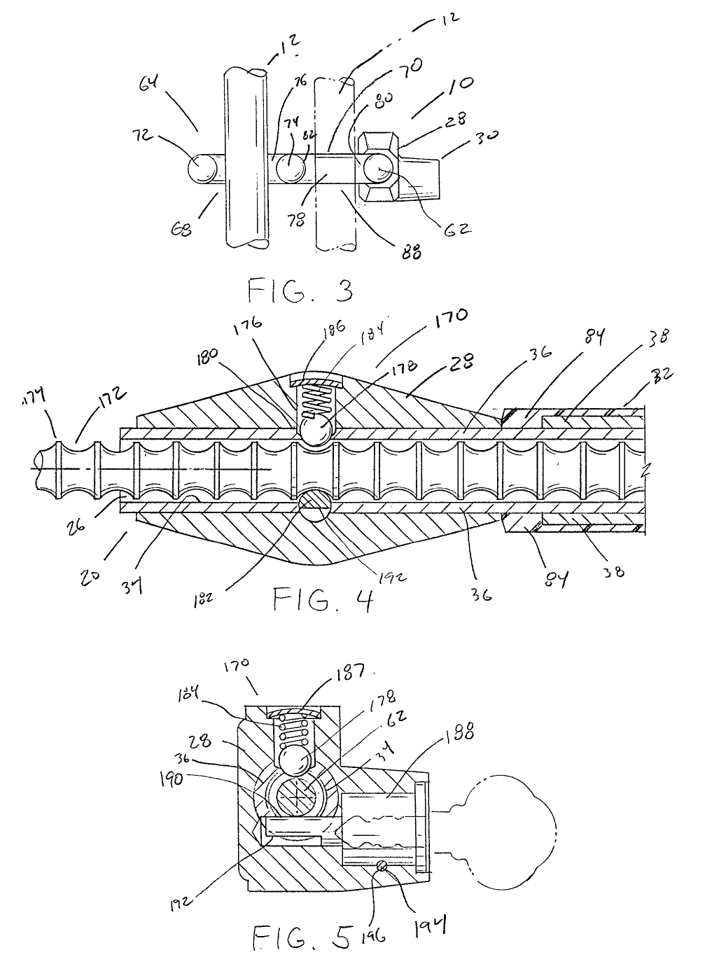

Handle member 16 further includes a rim engaging member 40 comprising a stand off 42 and an outwardly facing hook 44. Referring to FIG. 2, stand off 42 can be a bar portion 46 perpendicular to axis A and having a handle end 48 and a hook end 50. More particularly, handle end 48 of bar portion 46 is welded to the outer sleeve 38 of handle member 16 and extends perpendicular from handle member 16. Hook end 50, which is opposite of handle end 48, is secured to outwardly facing hook 44. Outwardly facing hook 44 comprises a first hook arm 52 and a second hook arm 54 which are generally parallel to one another and have inner ends commonly joined to web portion 56. When in the installed position, outer rim 12 of the steering wheel 14 is maintained between first and second hook arms 56, 58 and web portion 56.

Stand off 42 has a length L1 extending from handle end 48 to hook end 50 which defines the amount of off set between the engagement point of hook 44 and the outer sleeve 38 of handle 16 respectively. Further, length L1 of stand off 42 can be proportioned to produce a secondary hook portion 58 between second hook arm 54 and outer sleeve 38. Secondary hook portion 58 allows for the adjustment of the off set between the handle and rod members 16, 18 respectively and steering wheel hub 60. This adjustment ability provides greater protection of the air bag mechanism within the hub 60 by allowing the clearance between hub 60 and telescoping handle and rod members 16 and 18 to be optimized which will be discussed in greater detail below.

Rod member 18 includes an elongated rod 62 and a rim engaging member 64. Elongated rod 62 is of circular cross section wherein the outer diameter of rod 62 is dimensioned slightly less than the inner diameter of elongated passageway 34. This allows the elongated rod 62 of rod member 18 to freely telescopically move within handle member 16 and thus the ability of rim engaging members 40 and 64 to move relative to one another. The relative motion of members 40 and 46 allows the steering wheel lock 10 to be easily installed on the outer rim 12 of steering wheel 14 and allows the steering wheel lock 10 to be used in connection with outer rims 12 of differing diameters. In addition, elongated rod 62 includes a grooved portion 66 corresponding to lock mechanism 30 to interengage with the lock mechanism 30 which will be discussed in greater detail below.

Rim engaging member 64 comprises an outwardly facing hook 68 and a stand off 70. With respect to outwardly facing hook 68, included is a first hook arm 72 and a second hook arm 74 which is generally parallel to and spaced from first hook arm 72. Both first and second hook arms 72 and 74 have an inner end joined by web portion 76 and the three members interengage with rim 12 in similar fashion as outwardly facing hook 44. Stand off 70 has a bar portion 78 with a rod end 80 and a hook end 82 which produces a length L2 which defines the degree of off set between the point of engagement with rim 12 by hook 60 and the handle and rod members 16 and 18 respectively. As stated above with respect to stand off 42, length L2 of stand off 70 can be proportioned to produce a secondary hook portion 88 between second hook arm 74 and elongated rod 62. Secondary hook portion 88 allows for adjusting the off set between the hub 60 and handle and rod members 16 and 18 respectively. More particularly, the greatest offset between the steering wheel hub 60 and axis A of telescoping members 16 and 18 is produced when both outwardly facing hooks 44 and 68 of rim engaging members 44 and 64 respectively are utilized to interengage with the outer rim 12. However, an intermediate offset can be achieved if one of hooks 44 and 68 of rim engaging member 40 and 64 is used to interengage with the rim 12 while the secondary portions 58 or 88 of the other rim engaging members 40 and 64 respectively is utilized for the second contact point with the rim 12. This adjustment ability provides greater protection of the air bag mechanism within steering wheel hub 60 by allowing the necessary clearance between hub 60 and axis A of telescoping handle and rod members 16 and 18 but by allowing the user to more accurately maintain desired clearance.

It should be noted that rim engaging members 40 and 64 can be constructed of two bar members. In this respect, a single elongated bar can be utilized to produce the first hook arm 52, web portion 56 and bar portion 46 of rim engaging member 40 and that a similar elongated bar can be utilized to produce first hook arm 72, web portion 76 and bar portion 78 of rim engaging member 64. Single bar members can be utilized to produce second hook arm 58 and second hook arm 74. Further, in order to protect outer rim 12, steering wheel 14 and other interior components of the vehicle, steering wheel lock 10 should include a durable plastic coating encapsulating the portion of wheel lock 10 which engages at least one of these components. In this respect, durable plastic coating 84 is provided on elongated tube 32 and rim engaging member 40 and durable plastic coating 86 is provided on the end of elongated rod 62 and on rim engaging member 64.

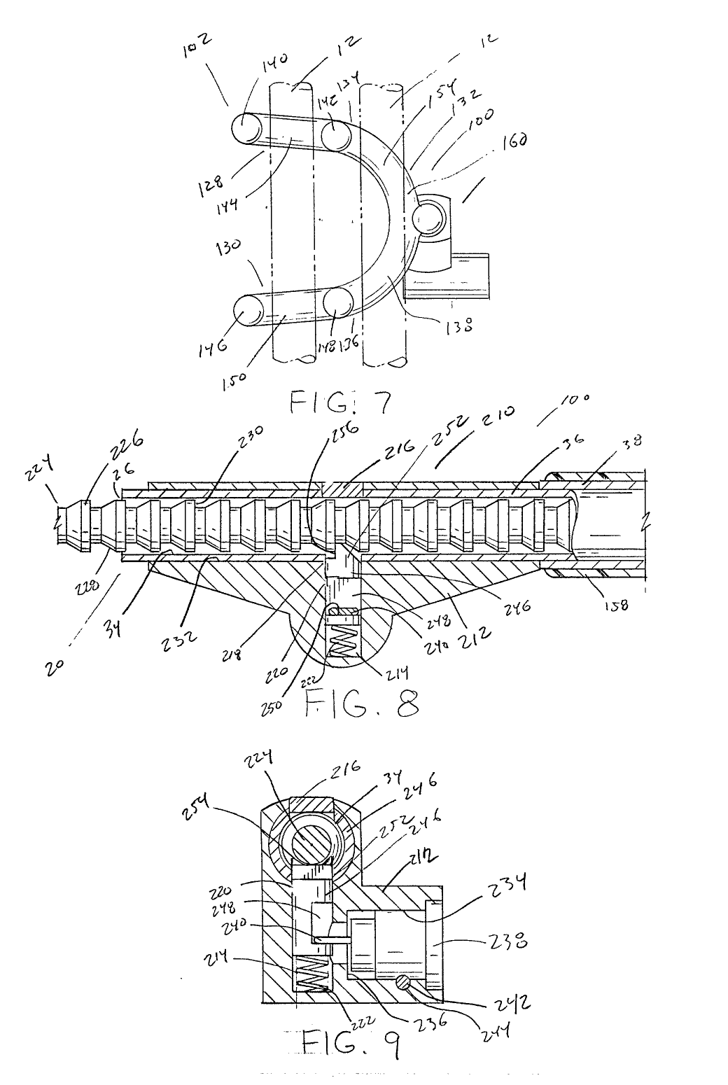

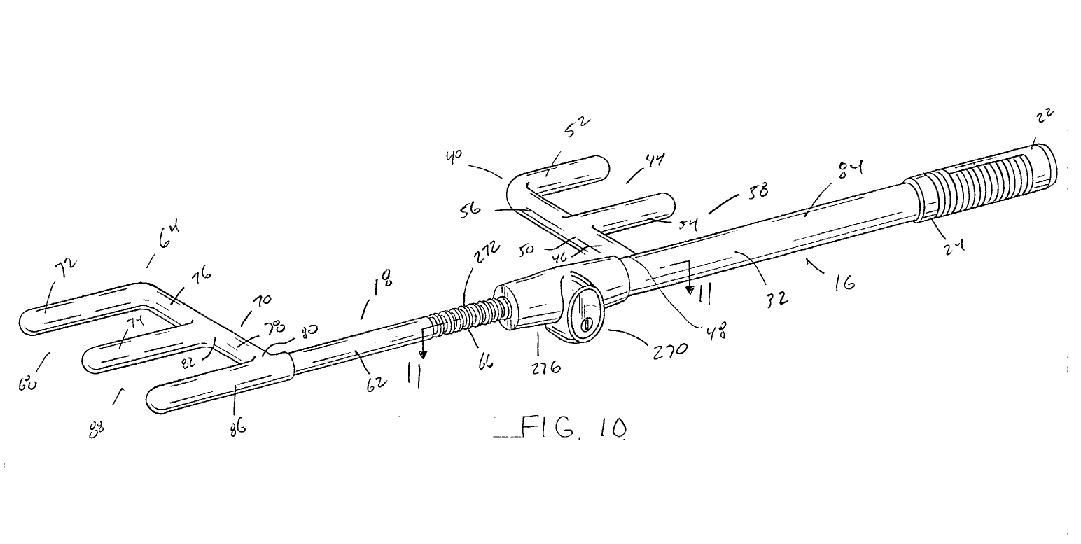

Referring to FIGS. 6 and 7, a second embodiment is shown, namely, steering wheel lock 100. Steering wheel lock 100 differs from steering wheel lock 10 only in that it includes differently configured rim engaging members 101 and 102. Accordingly, in order to simplify the description of this embodiment, the numbering with respect the remaining components of the steering wheel lock 100 is the same as that of steering wheel lock 10.

Rim engaging member 101 includes a first and a second laterally spaced outwardly facing hook 104 and 106 respectively which are configured similar to outwardly facing hook 44 of steering wheel lock 10. However, rim engaging member 101 is substantially U shaped and since rim engaging member includes two hooks 104, 106, it interengages with outer rim 12 at two points. In this respect, rim engaging member includes a U-shaped stand off 108 having a first end 110 and a second end 112 with a web portion 114 therebetween. First end 110 interengages with first hook 104 and second end 112 interengages with second hook 106. The center of web portion 114 is connected to outer sleeve 38 of handle member 16. As stated above, with respect to steering wheel lock 10, it is recommended that stand off 108 be welded to outer sleeve 38 even though other joining techniques may be utilized.

Referring to outwardly facing hooks 104 and 106 in greater detail, hook 104 is comprised of a first hook arm 116 and a second hook arm 118 which are generally parallel to one another and have inner ends commonly joined by web portion 120. When in the installed position, outer rim 12 of the steering wheel 14 is maintained between first and second hook arms 116, 118 and web portion 120. Hook 106 is comprised of a first hook arm 122 and a second hook arm 124 which are generally parallel to one another and have inner ends commonly joined by web portion 126. When in the installed position, outer rim 12 of the steering wheel 14 is maintained between first and second hook arms 122, 124 and web portion 126 at a point radially spaced from that of hook 104. Hooks 104 and 106 are generally equally spaced from outer sleeve 38 such that second hook arms 118 and 124 are in a common plane P1 parallel to a spaced from outer sleeve 38. More particularly, plane P1 is spaced from outer sleeve 38 a distance L3.

Rim engaging member 102 includes first and second laterally spaced outwardly facing hooks 128 and 130 respectively configured similarly to outwardly facing hooks 104 and 106 although facing in the opposite direction. Rim engaging member 102 includes a U-shaped stand off 132 having a first end 134 and a second end 136 with a web portion 138 therebetween. First end 122 is connected to first hook 116 while second end 124 is connected to second hook 118 thereby joining the hooks together to form the rim engaging member 102. U-shaped stand off 120 further includes a web portion 126 between the first and second ends 122 and 124 which is connected to elongated rod 62 at its center. As with rim engaging member 101, rim engaging member 102 also interengages with outer rim 12 at two points since it includes two hooks 128 and 130 Referring to hooks 128 and 130 in greater detail, hook 128 is comprised of a first hook arm 140 and a second hook arm 142 which are generally parallel to one another and have inner ends commonly joined by web portion 144. When in the installed position, outer rim 12 of the steering wheel 14 is maintained between first and second hook arms 140, 142 and web portion 144. Hook 130 is comprised of a first hook arm 146 and a second hook arm 148 which are generally parallel to one another and have inner ends commonly joined by web portion 150. When in the installed position, outer rim 12 of the steering wheel 14 is maintained between first and second hook arms 146, 148 and web portion 150 at a point radially spaced on rim 12 from that of hook 128. Hooks 128 and 130 are also generally equally spaced from elongated rod 62 such that second hook arms 142 and 148 are in a common plane P2 parallel to a spaced from elongated rod 62. More particularly, plane P2 is spaced from elongated rod 62 a distance L4.

The result of stand offs 108 and 132 is that the point of engagement between hooks 104,106,128 and 130 and rim 12 of steering wheel 14 is spaced from handle and rod members 16 and 18 based on the distance L3 and L4. Further, distance L3 and L4 of stand offs 108 and 132 can be proportioned to produce secondary hook portions 152 and 154 respectively. In this respect, when secondary hook portion 152 is utilized, rim engaging member 101 maintains rim 12 between second hook arms 118 and 124; stand off 108 and outer sleeve 38. When secondary hook portion 154 is utilized, rim engaging member 102 maintains rim 12 between second hook arms 142 and 148; stand off 132 and elongated rod 62. As discussed above, secondary hook portions 152 and 154 provide greater protection of the air bag mechanism within steering wheel hub 60. More particularly, the greatest offset between the steering wheel hub 60 and axis A of telescoping members 16 and 18 is produced when both outwardly facing hooks 104 and 106 of rim engaging member 102 and outwardly facing hooks 128 and 130 of rim engaging member 102 are utilized to interengage with the outer rim 12. However, an intermediate offset can be achieved if the hooks 104 and 106 or 128 and 130 of one rim engaging member 101 or 102 is used to interengage with the rim 12 while the secondary portions 152 or 154 of the other of rim engaging members 101 and 102 respectively are utilized for the diametrically opposite contact point with the rim 12.

Steering wheel lock 100 interengages with outer rim 12 at four points which adds additional protection. Further, by providing U shaped stand offs 108 and 132, first outwardly facing hooks 104 and 106; and second outwardly facing hooks 128 and 130 can be respectively mounted to outer rim 12 in the installed position about a steering wheel spoke. Referring to FIG. 7, first outwardly facing hook 128 and second outwardly facing hook 130 are shown mounted to outer rim 12 about steering wheel spoke 156 regardless of whether steering wheel spoke 156 extends transversely beyond outer rim 12.

It should be noted that rim engaging members 101 and 102 can be constructed of three bar members. With reference to rim engaging member 101 only since each are of similar design, a single formed bar member can be used to produce first hook arms 116 and 122; web portions 120 and 126 and standoff 108. Second hooks arms 118 and 124 can then be welded to the single formed bar.

It is recommended that elongated tube 32 and rim engaging member 101 are encapsulated by a durable plastic coating 158 while a portion of elongated rod 62 and rim engaging member 102 are encapsulated by durable plastic coating 160

Steering wheel locks 10 and 100 can include any locking mechanism 30 commonly known in the art. Referring to FIGS. 4 and 5, a deadbolt lock arrangement 170 is shown. In this arrangement, the grooved portion 66 of elongated rod 62 includes annular grooves 172, transverse to axis A of rod member 18 which are provided along a major portion of elongated rod 62. Annular grooves 172 are generally semi-circular and spaced axially along the grooved portion 66. Further, grooves 172 provide intermediate surfaces 174.

With respect to handle member 16, lock housing 28 is provided on opened end 20. Lock housing 28 includes locating hole 176 which houses locating ball 178. In this respect, inner sleeve 36 includes a hole 180 which is a smaller diameter than locating ball 178 thereby only allowing locating ball 178 to partially penetrate inner sleeve 36 and engage one of annular grooves 172. This ensures that one of annular grooves 172 is aligned to receive locking member 182. Locking ball 178 is urged into engagement with one of grooves 172 by spring 184. Locking ball 178 and spring 184 are maintained in locking hole 176 by plug 186.

Locking member 182 is actuated by a conventionally known key lock 188 and is generally cylindrical in shape wherein its arcuate outer surface 190 is of a diameter generally matching the diameter of annular grooves 172. Further, locking member 182 includes a recessed portion 192. When in the locked condition, the arcuate outer surface 190 of locking member 182 engages one of annular grooves 178 thereby preventing movement of rod member 18 relative to handle member 16. When locking member 182 is rotated generally 180° by key lock 188 such that recessed portion 192 faces annular grooves 172, lock 170 is in the unlocked condition and rod member 18 is able to freely telescopically move within handle member 16. Pin 194 is press fit into hole 196 to maintain the positioning of key lock 188.

Referring to FIGS. 8 and 9, a second lock assembly is shown, namely a ratcheting lock arrangement 210. Ratcheting lock arrangement 210 includes a lock housing 212 about inner sleeve 36 of handle 16. Further, lock housing 212 includes a blind hole 214 perpendicular to axis A and coaxial with holes 216 and 218 in inner sleeve 36. Blind hole 214 retains locking pawl 220 toward rod 224 by spring 222. As with elongated rod 62, rod 224 has a circular cross section and a diameter dimensioned slightly less than the inner diameter of elongated passageway 34; however, rod 224 includes a plurality of axially spaced ratchet teeth 226 which comprise a conical surface 228 extending radially outwardly in an axial direction away from the outer end of rod 224. Ratchet teeth 226 further includes an annular stop surface 230 extending perpendicularly to the axis A.

Lock housing 212 further includes a handle receiving hole 232 which is circular in cross section and has an inner diameter corresponding to the outer diameter of sleeve 36. Lock housing 212 further includes a key tumbler hole 234 having an inner end 236 opened to blind hole 214. Ratcheting lock arrangement utilizes a conventional key tumbler 238 received within key tumbler hole 234, wherein key tumbler 238 can rotate torque blade 240 which locks or unlocks the lock arrangement 210 which will be discussed in more detail below. Key tumbler 238 is maintained within hole 234 by pin 242 which is received in pin hole 244.

Locking pawl 220 comprises a shaft 246 which includes a recessed portion 248 having a back surface 250. On the rod engaging end 252, locking pawl 220 includes an annular end surface 254 and a stop surface 256. Torque blade 240 extends into the recessed portion 248 in locking pawl 220 to engage and cooperate with the back surface 250 to move pawl 220 from a locked position to an unlocked position. In this respect, spring 222 biases locking pawl 220 toward elongated rod 62 and into engagement with an annular stop surface 230 of ratchet tooth 226 on elongated rod 62 which is the locked position. The rod member 18 is thereby constrained from moving axially inwardly within tubular handle member 16. However, movement of rod member 18 axially outwardly of the tubular handle member outward of the tubular handle member 16 is provided by conical surface 228 of ratchet tooth 226 acting against annular surface 254 and angled plane 255 whereby the locking pawl 220 is moved inwardly into blind hole 214 against the force of spring 222 and thereby moves out of engagement with the ratchet teeth 226 to allow rod member 18 to be indexed outwardly and locking pawl to be indexed to the next ratchet tooth. The spring 222 then moves locking pawl outwardly to engage the corresponding annular stop surface 230 of the next ratchet tooth 226 to prevent inward movement.

Actuation of key tumbler 238 rotates the torque blade 240 to act against back surface 250 of locking pawl 220, whereby locking pawl 220 is moved away from ratchet teeth 226 which is the unlocked position. In this position, rod member 18 is free to move either outwardly or inwardly within tubular handle member 16.

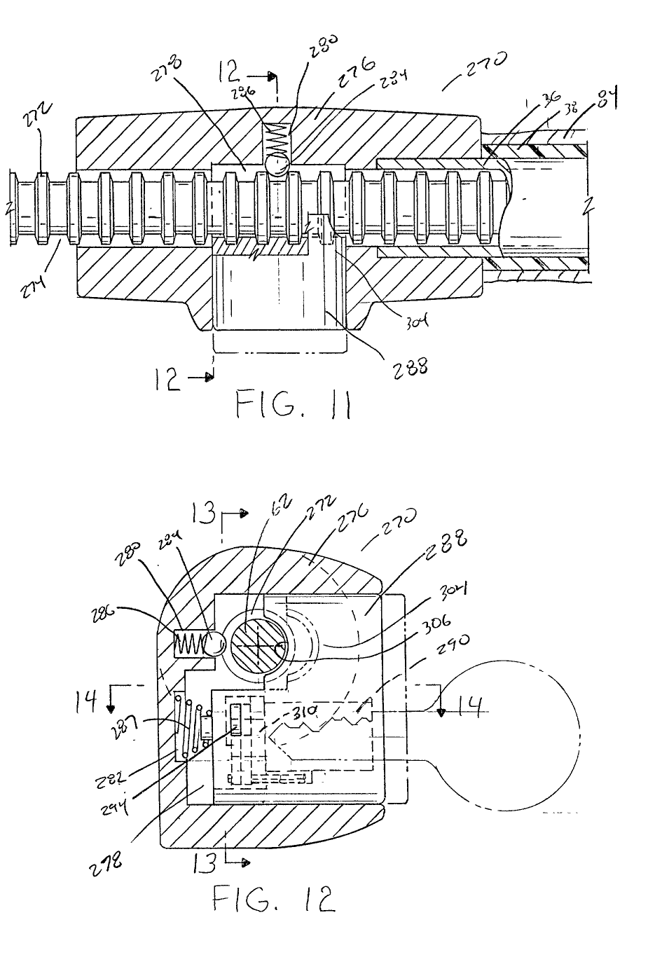

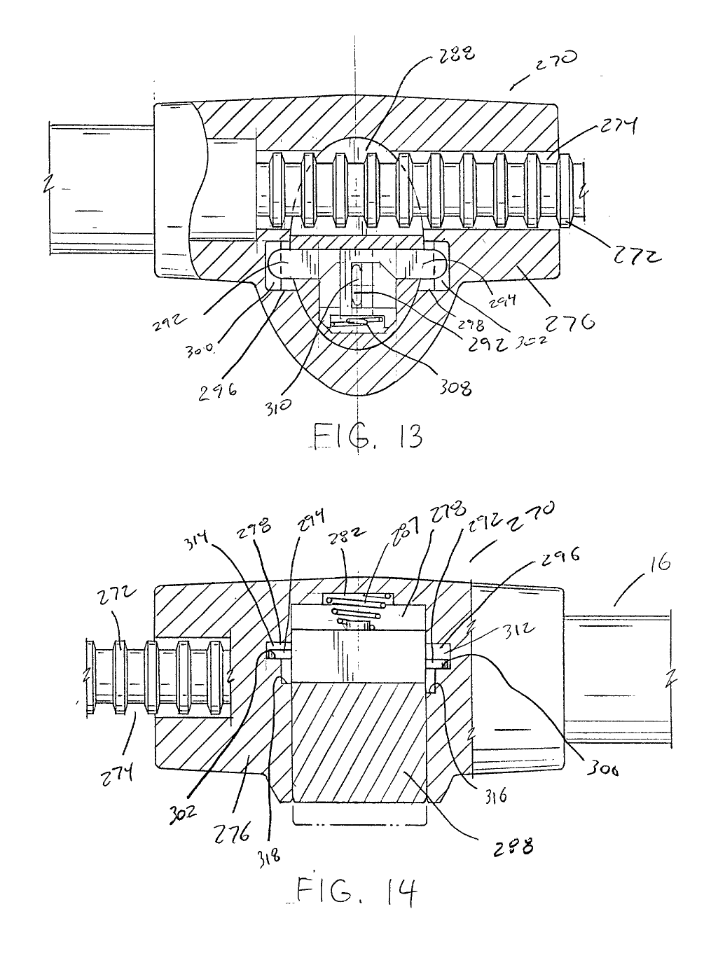

Referring to FIGS. 11-14, a third lock mechanism is shown, namely a push button style locking arrangement 270. More particularly, grooved portion 66 of elongated rod 62 includes ring shaped teeth 272 separated by recesses 274. Lock housing 276 has a blind hole 278 which is noncircular and has a first and second spring containment holes 280 and 282 respectively. With reference to spring hole 280, this hole contains a locating ball 284 which is biased toward elongated rod 62 by spring 286. Locating ball 284 has a diameter slightly less than spring containment hole 280 but larger than the width of recess 274 so that locating ball only partially penetrates recess 274 and is forced away from elongated rod 62 by annular teeth 272 as elongated rod 62 is moved inwardly or outwardly from tubular handle member 16. Blind hole 278 is shaped to receive and retain locking member 288 in an inward or locked position and in an outward or unlocked position.

Locking member 288 comprises a key tumbler 290 which locks and unlocks arrangement 270 by actuating locking blades 292 and 294 that work in connection with spring 287. In this respect, recess 274 further includes lateral pockets 296 and 298 that are generally L shaped wherein stop surfaces 300 and 302 respectively form part of the base of the L. In addition, blades 292 and 294 are shaped to be received in pockets 296 and 298 respectively. Blades 292 and 294 are controlled by key tumbler 290 in that when in the locked condition, blades 292 and 294 are biased outwardly by spring 308. When key tumbler 290 is rotated to the unlocked condition, blades 292 and 294 are drawn partially out of lateral pockets 296 and 298 respectively. However, blades 292 and 294 are not completely withdrawn from pockets 296 and 298 which prevents locking member 288 from becoming detached.

Lock arrangement 270 is put into the locked condition by rotating key tumbler 290 to the locked position, wherein spring 308 forces blades outwardly. Then, the user pushes locking member 288 into blind hole 278. As blades 292 and 294 pass stop surfaces 300 and 302, blades 292 and 294 are urged outwardly by spring 308 into the base portions 312 and 314 of pockets 296 and 298 and member 288 is in the locked condition. The interengagement between blades 292 and 294 and stop surfaces 300 and 302 then maintain lock member 288 in its inward or locked position. In order to unlock arrangement 270, the key tumbler is rotated to the unlocked position, wherein torque blade 310 drives blades 292 and 294 inwardly until they clear stop surface 300 and 302 respectively which allow spring 287 to urge lock member 288 outwardly to its unlocked position. As stated above, lock member 288 is retained in blind hole 278 by the partial retraction of torque blades 292 and 294. As a result, locking member 288 is urged outward by spring 287 until torque blades 292 and 294 engage stop surfaces 316 and 318 respectively which is the unlocked position.

Locking member 288 further includes rod engaging portion 304 having annular recess 306 shaped to receive a portion of one of the annular teeth 272. When locking member 288 is in its inward or lock position, annular recess 306 of rod engaging portion 304 interengages with one of annular teeth 272 to prevent movement either outwardly or inwardly of rod member 18 relative to tubular handle member 16. As locking member 288 moves outwardly, annular recess 306 of rod engaging portion 304 disengages annular tooth 272 thereby allowing rod member 18 to move freely inwardly and outwardly from handle member 16.

While considerable emphasis has been placed on the embodiments of the invention, illustrated and described herein, it will be appreciated that other embodiments can be made and that many changes can be made in the embodiments without departing from the principles of the invention. Accordingly, it is distinctly understood that the foregoing descriptive matter is to be interpreted merely as illustrative of the invention and not as a limitation.

I claim:

1. An anti-theft device for preventing unauthorized use of an automobile by prohibiting rotation of the steering wheel when said device is in an installed position, the steering wheel having an outer rim and a central hub extending outwardly beyond the rim, said device comprising:
first and second members telescoping along an axis with a lock for securing said members in an extended locked condition, a first hook on said first member for engaging said rim of the steering wheel when said members are in said extended condition, a second hook on said second member for engaging said rim of the steering wheel when said members are in said extended condition, the improvement comprising a first stand off element on at least one of said first and second hooks for spacing said axis a first distance from said rim.

2. An anti-theft device of claim 1, wherein said first stand off is a bar having a first end and a second end, said first end interengaging said at least one first and second hook and said second end interengaging at least one of said first and second telescoping members.

3. An anti-theft device of claim 2, wherein said bar has an axis substantially perpendicular to said telescoping member axis.

4. An anti-theft device of claim 1, further including a third hook on at least one of said first and second telescoping members and adjacent to at least one of said first and second hooks.

5. The anti-theft device of claim 1, further including a second stand off element on the other of said at least one of said first and second hooks for spacing said axis a second distance from said rim.

6. The anti-theft device of claim 5, wherein said first and second distances are equal.

7. The anti-theft device of claim 5, wherein said first stand off is a first bar having a first end interengaging said first member and a second end interengages said first hook and said second stand of is a second bar having a first end interengaging said second member and a second end interengaging said second hook.

8. The anti-theft device of claim 7, wherein said first bar has a first bar axis and said second bar has a second bar axis, said first and second bar axis being substantially perpendicular to said telescoping member axis.

9. The anti-theft device of claim 5, further including a third hook on said first telescoping member adjacent said first hook and a fourth hook on said second telescoping member adjacent said second hook.

10. The anti-theft device of claim 9, wherein said first and second stand offs are U-shaped bar members having ends and a central web portion, said first and third hooks interengage said ends of said first stand off and said first member interengaging said web of said first stand off, and said second and fourth hooks interengage said ends of said second stand off and said second member interengaging said web of said second stand off.

11. An anti-theft device for preventing unauthorized use of an automobile by prohibiting rotation of the steering wheel when said device is in an installed position, the steering wheel having an outer rim and a central hub extending outwardly beyond the rim, said device comprising:
an elongated tubular member having an axis, an outer end, an opened end, and an elongated passageway extending inwardly from said opened end toward said outer end along said axis; an elongated rod having an inner end, an outer end and an axis co-axial with said tubular member axis, said inner end being telescopically received in said elongated passageway; a lock associated with said tubular member having a locked condition and an unlocked condition, said rod being prevented from telescopically retracting into said opened end when said lock is in said locked condition, said lock being in said locked condition when said device is in said installed position; a first rim engaging member extending from said tubular member between said opened end and said outer end and having at least one outwardly facing hook for selective interengagement with said rim and a first stand off for spacing said first hook a first distance from said tubular member axis; a second rim engaging member extending from said rod between said outer and inner ends and having at least one outwardly facing hook for selective interengagement with said rim and a second stand off for spacing said third hook a third distance from said rod axis.

12. The anti-theft device of claim 11, wherein said first stand off is a bar having a first and a second end, said first end of said first stand off being interengaged with said tubular member and said second end of said first stand off being interengaged with said at least one hook of said first rim engaging member; and said second stand off is a bar having a first end and a second end and said first end of said second stand off being interengaged with said at least one hook of said second rim engaging member.

13. The anti-theft device of claim 12, wherein said first stand off has an axis substantially perpendicular to said axis of said tubular member and said second stand off has an axis substantially perpendicular to said axis of said elongated rod.

14. The anti-theft device of claim 11, wherein said at least one hook of said first rim engaging member is two adjacent hooks and said at least one hook of said second rim engaging members is two adjacent hooks.

15. The anti-theft device of claim 14, wherein said first and second stand offs are U-shaped bars having two ends and a central web, said central web of said first stand off being connected to said tubular member and said web of said second stand off being connected to said rod, said first and third hooks being connected to said ends of said first stand off and said second and fourth hooks being connected to said second stand off.
